(19) United States
(12) Patent Application Publication
(10) Pub. No.: US 2006/0214322 A1
(43) Pub. Date: Sep. 28, 2006

(54) IN-MOLD DECORATION FABRICATION OF INJECTION MOLDING

(76) Inventors: Dean-Kuo Liu, Taoyuan County (TW); Chuan-Shien Yu, Taipei City (TW); Lu-Chin Wu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/908,985

(22) Filed: Jun. 3, 2005

(30) Foreign Application Priority Data
Mar. 22, 2005 (TW) 94108740

(51) Int. Cl. B29C 45/14

(52) U.S. Cl. 264/132; 264/272.14

(57) ABSTRACT

An in-mold decoration fabrication of injection molding is provided as follows. First, a plastic substrate is provided and a mask is disposed on the plastic substrate. A patterned metal film is formed on a surface of the plastic substrate without covering the mask. After the mask is removed, an ink pattern is formed selectively on the patterned metal film. Then, a plurality of forming units on the plastic substrate are preformed and separated to each other by trimming the plastic substrate. Finally, a step of resin injection is provided to cover the patterned metal film, ink pattern of each of the forming units and the exposed surface thereof.

### CROSS-REFERENCE TO RELATED APPLICATION

This application claims the priority benefit of Taiwan application serial no. 941 08740, filed on Mar. 22, 2005. All disclosure of the Taiwan application is incorporated herein by reference.

### BACKGROUND OF THE INVENTION

1. Field of Invention

The present invention relates to fabrication of injection molding, and specifically to the fabrication of in-mold decoration (IMD).

2. Description of Related Art

The conventional technology of in-mold decoration combines with the fabrication processes of ink printing, pre-forming, trimming and resin injection. These fabrication processes can be used in accordance with film material having different type and property, by the auxiliary work with molds of pre-forming, trimming, resin injection and so on, so as to fabricate the mechanical structures which are suitable for use in consumer electronics, computers, telecommunication products, car interior accessories, information appliances, and so on.

In general, the surface of those products, fabricated from the in-mold decoration fabrication of injection molding, has a film layer which is made by transparent plastic material. This film is used to protect the ink printing pattern at bottom layer from scratching. It can also let the ink printing pattern stay longer. Therefore, the conventional technology of directly performing on the structure member with spraying, pad printing, water transfer printing, hot stamping or double injection has been gradually replaced by the in-mold decoration technology.

Accordingly, if the injection product is asked to have a coating film with metal-like-texture quality, a metal coating process needs to be processed prior to ink printing. This requires several steps. First, a blanket metal film needs to be formed on the plastic substrate, then the metal film is etched in order to remove unwanted portion of metal film. Second, it uses a screen which forms the ink pattern to press the ink pattern on the metal film. Finally, once the ink dries by baking, it is performed with the steps of pre-forming, trimming, and resin injection, and thus a product fabricated by the in-mold decoration can be accomplished.

However, one thing needs to be mentioned. The above fabrication can not be applied for a product fabricated by outer window frame of injection molding. It is because that the metal film on the transmittance window still has a residue of a transparent metal oxide layer after etching. This metal oxide layer not only affects the clarity and transmittance of the window but also affects the adherence between the plastic base and injection plastic in subsequent process. Consequently, when the injection plastic is cooled and solidified, it can cause the issue of poor reliability due to bad packaging or stripping away.

### SUMMARY OF THE INVENTION

An objective of the invention is to provide a fabrication process of the in-mold decoration along with the assistance of auxiliary tools. This can avoid metal-oxide layer formed between the plastic substrate and the injection plastic. Thus, it increases the reliability of fabrication.

The invention provides a fabrication process for in-mold injection of injection molding. The method includes the following steps. First, a plastic substrate is provided and at least one mask is disposed on the plastic substrate. A patterned metal film is formed on a surface of the plastic substrate without covering the mask. After the mask is removed, an ink pattern is selectively formed on the patterned metal film. Then, a plurality of formed units are formed on the plastic substrate by pre-forming process and the formed units are separated from each other by trimming the plastic substrate. Finally, a step of resin injection is performed to cover the patterned metal film, the ink pattern on each of the forming units and the exposed surface of each of the formed units.

According to the preferred embodiment of the invention, the plastic substrate is, for example, a transparent film. A fixture is, for example, used in order to hold the mask on the plastic substrate. Then, an adhering tape is used to affix the fixture onto the plastic substrate. Alternatively, a vacuum tape can be used to firmly secure the mask onto the plastic substrate.

According to a preferred embodiment of the invention, the shape of the surface of the plastic substrate, not covered by the mask, includes a frame shape. In addition, the region of the plastic substrate, covered by the mask, includes a transmittance window.

According to a preferred embodiment of the invention, the method to form patterned metal film includes chemical vapor deposition (CVD) process or physical vapor deposition (PVD) process. In addition, the method to form the ink pattern includes, for example, a screen printing process.

The invention uses the pre-patterned mask to cover a portion of the plastic substrate not formed with the metal film, such as the transmittance window, and the mask is removed after the patterned metal film is formed. Therefore, the fabrication process of the invention can overcome the conventional adherence problem for the metal-oxide layer formed between the plastic substrate and injection plastic. Particularly, when the invention is applied to the injection product for outer window frame, the window surface will not have any residue of metal-oxide layer which is caused by the conventional etching process. The invention thus effectively increases the reliability of the injection product.

In order to easily understand the invention, the characteristics, advantages and other purposes, a real example with Figures are shown in the following.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 to FIG. 6 are the cross-sectional drawings, schematically illustrating the fabrication processes of injection by the in-mold decoration, according to a preferred embodiment of the invention.

FIG. 7 is a top view, schematically illustrating a mask used in the fabrication processes, according to a preferred embodiment of the invention.

### DESCRIPTION OF THE PREFERRED EMBODIMENT

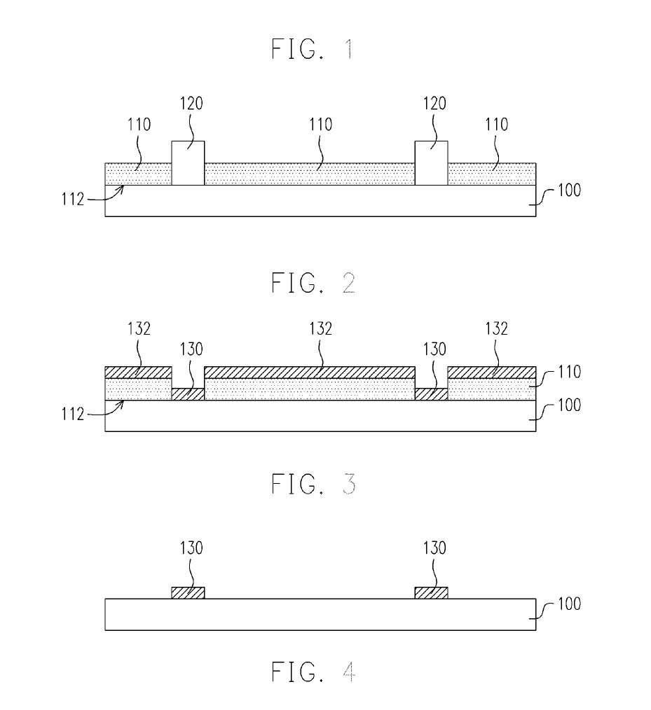

FIG. 1 to FIG. 6 are the cross-sectional drawings, schematically illustrating the fabrication processes of injection by the in-mold decoration, according to a preferred embodiment of the invention. In FIG. 1 and FIG. 2, a plastic substrate 100 is provided and used as an inner film of injection molding. One or several masks 110 are affixed on the plastic substrate 100. The mask 110 can be disposed at a specific position by using, for example, a fixture 120 to precisely align to the corresponding specific position. And, the mask 110 can be further firmly adhered to the plastic substrate 100 by, for ample, using an adhering material 112 or affixed on the plastic substrate 100 by a vacuum tape (not shown in drawing). This can avoid the occurrence of outgassing problem when the coating is performing. In this example, no matter for a single-piece mask 110 or multiple-piece masks 110, any surface region of the plastic substrate 100, at which the metal film is not formed, can be covered by the pre-patterned mask(s) 110. After the patterned metal film, will be described lately, is completely formed, then the mask 110 is removed. The further descriptions of implementation for the mask 110 in detail can be referred to the later descriptions.

Referring to FIG. 3 and FIG. 4, after the fixture 120 is removed, a patterned metal film 130 is formed on the surface of the plastic substrate 100, not being covered with the mask 110, by using sputtering or vapor deposition, such as PVD or CVD process. In the mean time, the mask 110 is also covered with metal film 132, which is not to be used. Then, when mask 110 is removed, only the patterned metal film 130 remains on the plastic substrate 100. Remarkably, in conventional technology, there is some metal-oxide residue on the plastic substrate after the metal film is entirely formed and is etched to remove the un-wanted portion of the metal film. In this invention, the mask 110 is used to replace the etching process. This can save the consumption of photoresist, etchant, stripper solution for photoresist, and ionized water solution for cleaning. Therefore, environmental pollution is reduced. Moreover, the mask 110 has been proved to be able to avoid the formation of metal-oxide and can also be used repeatedly and further saving fabrication cost.

Referring to FIG. 5 and FIG. 6, an ink pattern 140 is selectively formed on the surface of the patterned metal film 130. The ink pattern 140 can be formed by, for example, a screen printing process. And, various ink patterns can be formed, associating with the patterned metal film 130 for presenting high quality texture. Of course, the formation of ink pattern 140 is not limited to the printing process. The ink pattern 140 can also be obtained with imprinting or other processes. After the ink pattern 140 dries by baking, the steps of forming, trimming, and resin injection can be performed to accomplish the formation by the in-mold decoration fabrication of injection molding. FIG. 6 shows a model unit 102 after trimming. The surface on the model unit 102, including the patterned metal unit 130, the ink pattern 140 and the exposed region of the model unit 102 is covered by an injection plastic 150. Although the invention does not show the three dimensional structure of the model unit 102, which has undergone pressurized and vacuum heating processes in this example, but only shows the cross-sectional drawing of the model unit 102 for descriptions, this invention is not limited in this descriptions.

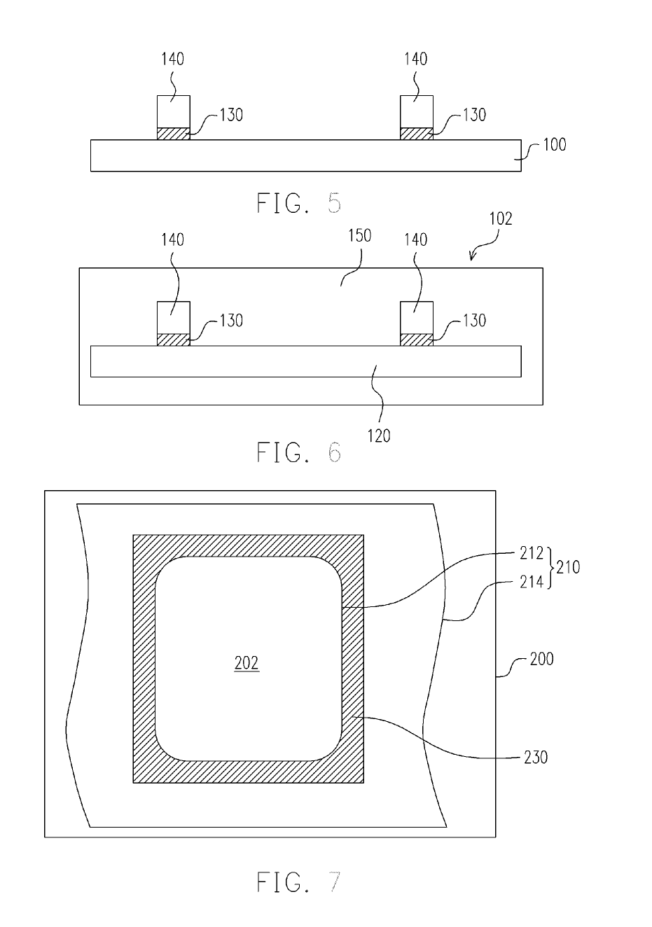

FIG. 7 is a top view, schematically illustrating a mask used in the fabrication processes, according to a preferred embodiment of the invention. The mask 212 and the mask 214 have been trimmed with appropriate shapes and sizes. Then they are placed on the plastic substrate 200, forming a patterned mask 210. The surface on plastic substrate 200, which is not covered by the mask 212 and the mask 214, forms a frame shape, for example. Therefore, after the foregoing processes of sputtering or deposition is performed to form the metal film 230, the metal film 230 with a frame pattern is formed on the plastic substrate 200. The covered area by the mask 212 forms, for example, the transmittance window 202. Therefore, the final injection product is the window which possesses metal frame quality. This can be applied to the outer frame structure for the LCD panel, the touch panel or the outer protection structure for lens.

From the descriptions above, the invention adopts pre-patterned mask in order to cover a region of the plastic substrate surface, which cannot have metal film, such as the window portion. After the patterned metal film is formed, the mask can then be removed. Therefore, the fabrication process of this invention can overcome the conventional adhering problem for the metal-oxide between the plastic substrate and injection plastic. The invention can particularly applied to those outer window frames of injection products. The window surface will not have the metal-oxide residue, which is caused by the conventional etching process. The invention thus effectively increases the reliability of the injection product.

In conclusion, the invention of this in-mold decoration fabrication has several advantages.

Masks are used to replace the conventional etching process. This can reduce environmental pollution and the mask can be used repeatedly, saving fabrication cost.

The adherence between the plastic substrate and injection plastic increases. It is not easy to be stripped away; and it then increases the packaging reliability thereafter.

Although a better example has been mentioned above to explain this invention, it does not limit to this invention. It will be apparent to those skilled in the art that various modifications and variations can be made to the structure of the present invention without departing from the scope or spirit of it. In view of the foregoing, it is intended that the present invention cover modifications and variations of this invention provided they fall within the scope of the following claims and their equivalents.

What is claimed is:

1. A method of an in-mold decoration fabrication of injection molding, comprising:
providing a plastic substrate;
disposing at least a mask on the plastic substrate;
forming a patterned metal film on the plastic substrate without covering by the mask;
removing the mask;
selectively forming an ink pattern on the patterned metal film;
pre-forming a plurality of forming units on the plastic substrate;
trimming the plastic substrate to separate the forming units; and
respectively performing a resin injection to cover the patterned metal film, the ink pattern and an exposed surface of one of the forming units.

2. The method in claim 1, wherein the plastic substrate is a translucent film.

3. The method in claim 1, wherein a fixture is used in order to place the mask on the plastic substrate, and then the mask is adhered to the plastic substrate by adhering material.

4. The method in claim 1, wherein a vacuum tape is used to firmly secure the mask onto the plastic substrate.

5. The method in claim 1, wherein a surface region of the plastic substrate without being covered by the mask forms a frame shape.

6. The method in claim 1, wherein a surface region of the plastic substrate being covered by the mask forms a transmittance window.

7. The method in claim 1, wherein the step of forming the patterned metal film comprises chemical vapor deposition (CVD) process or physical vapor deposition (PVD) process.

8. The method in claim 1, wherein the step of forming the ink pattern comprises a screen printing process.
